(19) United States
(12) Patent Application Publication
(10) Pub. No.: US 2012/0109991 A1
(43) Pub. Date: May 3, 2012

(54) Input correction system based on translation search and method thereof

(75) Inventors: Chaucer Chiu, Taipei (TW); Hui Wang, Shanghai (CN)

(73) Assignee: INVENTEC CORPORATION, Taipei (TW)

(21) Appl. No.: 12/928,624

(22) Filed: Dec. 14, 2010

(30) Foreign Application Priority Data
Oct. 28, 2010 (TW) 099136871

(51) Int. Cl. G06F 17/30

(52) U.S. Cl. 707/760; 707/E17.009

(57) ABSTRACT

An input correction system based on translation search and the method thereof are provided. The invention searches a translation word according to a search message. When the translation word does not exist, the search message is compared with all similar messages in order to locate a matched word message. The word message is then taken as the search message to search the translation word again. The mechanism improves the convenience in searching for translation words.

### BACKGROUND OF THE INVENTION

1. Field of Invention

The invention relates to a correction system and the method thereof. In particular, the invention is an input correction system that corrects an input search message for translation search based on similar sounds and the method thereof.

2. Related Art

In recent years, the popularity of Internet and trend in internationalization, there are more opportunities for user to encounter documents in other languages. Therefore, a lot of translation procedures are invented.

Generally speaking, a translation procedure has a translation database stored with translation words and their corresponding explanations. After a user keys in a search message, the procedure finds a matched translation word from the translation database. The user can thus learn the meaning of the word. However, when the user cannot correctly enter the translation word, even off by one letter, the translation procedure cannot find the corresponding explanation. This is very inconvenient for many users.

In view of this, some vendors provide the options of showing translations words similar to the search message when no matched translation word can be found. Hence, even if the user cannot correctly enter the translation word, he can still browse similar translation words to find what he wants and learn the corresponding meaning. However, this method is still not perfect for users who only know the pronunciation of the translation word. For example, the translation procedure cannot find translation words based on pronunciation or similar-sounding words. Suppose a user enters ‘fiziks’ as a similar-sounding word (search message), then the above-mentioned translation procedure cannot use this information to find a similar-sounding translation word ‘physics’. Instead, it finds other translation words similar in spelling. There is still such inconvenience in searching translation words for users.

In summary, the prior has long had the problem with search corrections based on similar-sounding words. It is thus imperative to provide a better solution.

### SUMMARY OF THE INVENTION

In view of the foregoing, the invention discloses an input correction system for translation searches and the method thereof.

The disclosed input correction system for translation searches includes: a translation database, a similar-sound database, a searching module, a loading module, and a correcting module. The translation database stores multiple translation words, each of which contains an explanation. The similar-sound database stores multiple word messages along with the corresponding similarity messages and weights. The searching module receives a search message and uses the search message to find a matched translation word from the translation database. When a matched translation word exists, the loading module loads the translation word to display the meaning thereof. When a matched translation word does not exist, the search message is compared with all the similar messages. When there is a matched similar message, the corresponding word message and weight are loaded. The correcting module lists and displays the loaded word messages according to the weights. After selecting any one of the loaded word messages, the selected word message is used as the search message to find a matched translation word in the translation database. The corresponding word explanation is then displayed.

The disclosed input correction method for translation searches includes the steps of: providing a translation database having multiple translation words, each of which has a word explanation; providing a similar-sound database having multiple word messages along with the corresponding similarity messages and weights; receiving a search message and finding a matched translation word from the translation database accordingly; when a matched translation word exists, loading the translation word to display the word explanation thereof and, when a matched translation word does not exist, comparing the search message with all the similar messages and loading the word messages and weights for matched similar messages; displaying the loaded word message according to the weights and, after one of the loaded word messages is selected, using the selected word message as the search message to find a matched translation word from the translation database and displaying the word explanation thereof.

The disclosed system and method differ from the prior art in that the invention uses the search message to search for a matched translation word. When a matched translation word does not exist, the search message is compared with all the similar messages to find a matched word message. The word message is then used as the search message to find a matched translation word again.

Through the above-mentioned techniques, the invention improves the convenience in searching for translation words.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed input correction system for translation searches;

FIG. 2 is a flowchart of the disclosed input correction method for translation searches;

FIG. 3 is a schematic view of the translation window in the invention;

FIGS. 4 to 6 are schematic views showing how to search for translation words according to the invention; and

FIG. 7 is a schematic view of adjusting the pull-down menu to half-transparent according to the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

Before explaining the input correction system and method for translation searches, the terms used herein are defined as follows. The word message in this specification means a non-mother-tongue word without the word explanation, e.g., ‘apple’. Each word message has corresponding similarity messages and weights. The similarity message is the string composed of spelling letters (or similar-sounding word). Take the word message ‘apple’ as an example. Its similarity message can be ‘apo’, ‘apol’, etc. The weight is the number of time a word message is used. A larger weight means more commonly used. A smaller weight means less commonly used.

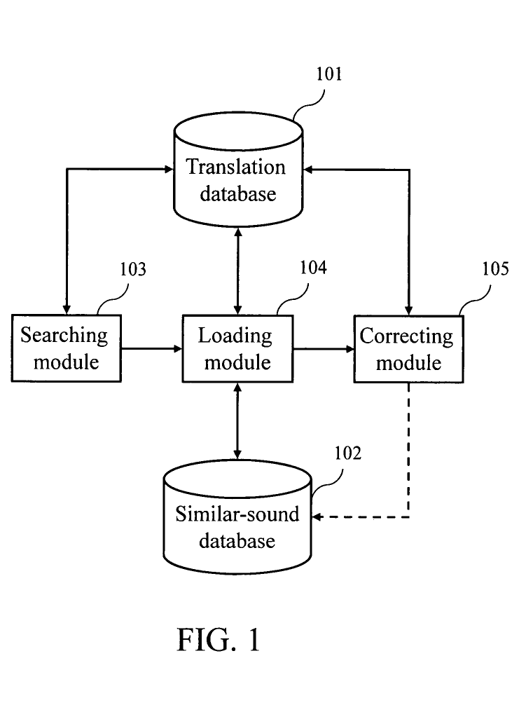

Please refer to FIG. 1. The disclosed input correction system for translation searches includes: a translation database 101, a similar-sound database 102, a searching module 103, a loading module 104, and a correcting module 105. The translation database 101 stores translation words, each of which has a word explanation. For example, the translation word ‘This’ has the word explanation ‘This (in Chinese)’. In practice, the translation database 101 can be implemented using a relational database or file document.

The similar-sound database 102 stores multiple word messages along with the corresponding similarity messages and weights. In practice, the similar-sound database 102 can also be implemented using a relational database or file document (e.g., a correspondence table). It further allows the user to add, edit, and delete the word messages in the similar-sound database 102, along with their similarity messages and weights. The word message, similarity message, and weight have been defined before. They are not repeated here again.

The searching module 103 receives a search message and uses the search message to find a matched translation word in the translation database 101. For example, suppose the received search message is ‘apple’. The searching module 103 compares the search message with all the translation words in the translation database 101. If the translation database 101 has the translation word ‘apple’ with the word explanation ‘apple (in Chinese)’. Then the translation word ‘apple’ is obtained. This means that a matched translation word exists in the translation database 101.

When a matched translation word exists, the loading module 104 loads the translation word to display the word explanation thereof. In the above example, since the matched translation word ‘apple’ exists, the loading module 104 loads the translation word ‘apple’ to show the word explanation ‘apple (in Chinese)’. If the search message received by the searching module 103 is ‘apo’ and the translation database 101 does not have the translation word ‘apo’ (i.e., no matched translation word exists), then the loading module 104 compares the search message ‘apo’ with all the similarity messages in the similar-sound database 102. According to a matched similarity message, the corresponding word message and weight are loaded. For example, suppose the similar-sound database stores the word message ‘apple’ that has a corresponding similarity message ‘apo’ and weight ‘5’. When the loading module 104 makes a comparison, the similarity message ‘apo’ matches. Therefore, the system obtains the corresponding word message ‘apple’ and its weight ‘5’.

The correcting module 105 displays loaded word message according to their weights and allows the user to select one of them. The selected word message is used as the search message to find a matched translation word in the translation database 101 and display the corresponding word explanation. For example, suppose no matched translation word exists. The loading module 104 loads multiple word messages and weights, e.g., “word message ‘apple’ with weight ‘5’” and “word message ‘apolar’ with weight ‘3’.” In this case, the correcting module 105 displays the loaded word messages according to their weights. For example, the word messages with larger weights are listed before those with smaller weights. Afterwards, the user is allowed to select one of the word messages (e.g., ‘apple’). The user selected word message ‘apple’ is then used as the search message for finding a matched translation word in the translation database 101 and displaying its word explanation. It should be mentioned that when displaying the loaded word messages according to weights, the word messages can be listed in the pull-down menu in ascending or descending order of the weights. The pull-down menu can be adjusted to be half-transparent by pressing a functional key or clicking.

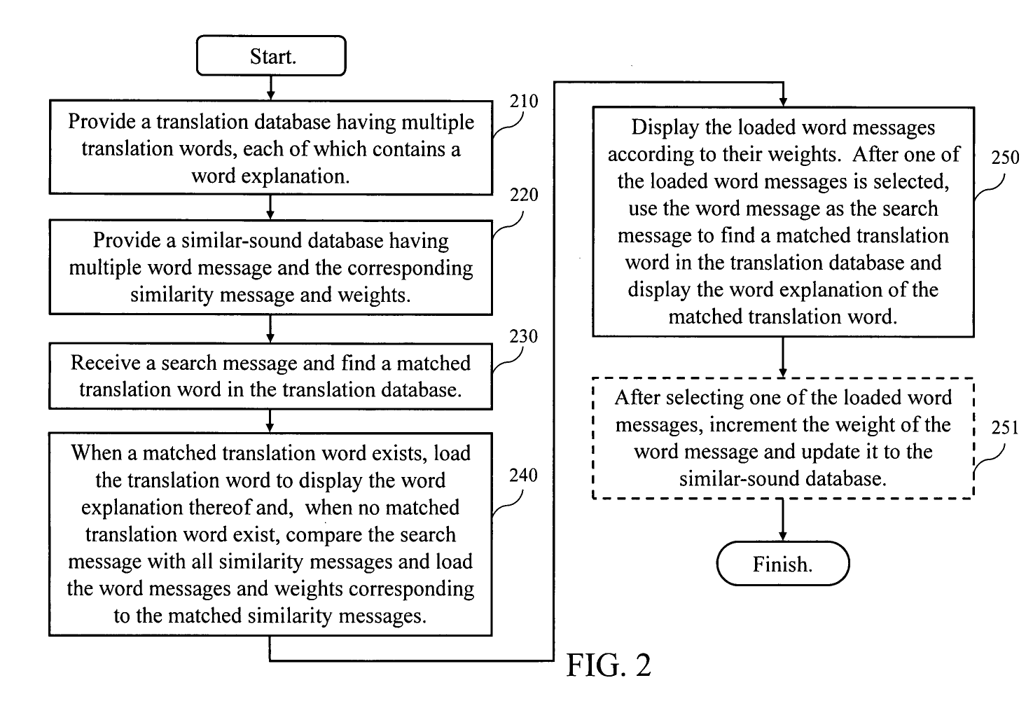

Please refer to FIG. 2. The disclosed input correction method for translation searches includes the following steps. Step 210 provides a translation database 101 having multiple translation words, each of which has a word explanation. Step 220 provides a similar-sound database 102 having multiple word messages along with corresponding similarity messages and weights. Step 230 receives a search message and uses the search message to find a matched translation word in the translation database 101. In step 240, when a matched translation word exists, the translation word is loaded to display the word explanation thereof or when no matched translation word exists, the search message is compared with all the similarity messages to load the word messages and weights for the matched similarity messages. Step 250 displays the loaded word messages according to their weights and, after one of the loaded word messages is selected, uses the selected word message as the search message to find a matched translation word in the translation database 101 to display its word explanation. Through the above steps, the search message is used to find a matched translation word. If no matched translation word exists, the search message is compared with all the similarity messages to find a matched word message. The word message is then taken as the search message to find a matched translation word again.

After step 250 and after the user selects one of the loaded word messages, the weight of the selected word message is increased and updated to the similar-sound database 102 (step 251). It should be noted that although the weight is increased in this example, any way of computing a new weight should be included under the invention as well.

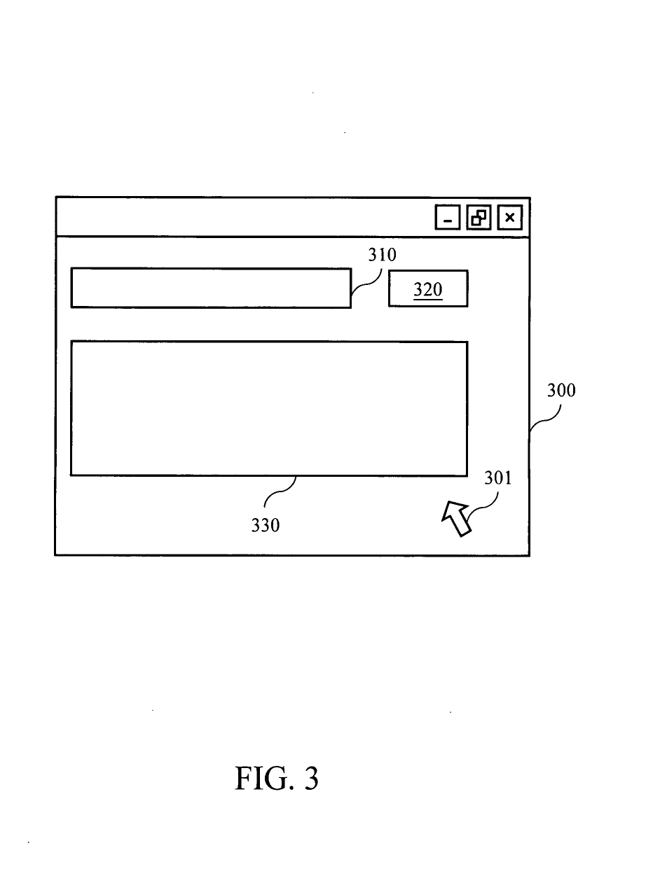

Please refer to FIGS. 3 to 7 for an embodiment of the invention. With reference to FIG. 3, the translation window 300 according to the invention includes: an input area 310, a search element 320, and a display area 330. In practice, the translation window 300 can be operated via the cursor 301 or functional keys. It should be emphasized that the invention does not impose any restriction on the number and type of elements in the translation window 300.

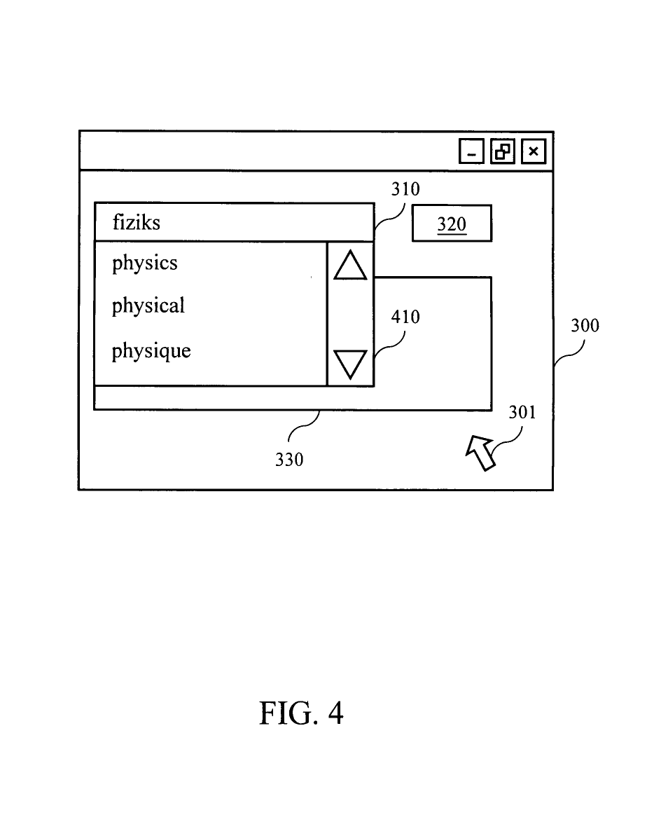

Please refer to FIGS. 4 to 6. In FIG. 4, when the user only knows the pronunciation of a translation word and wants to look it up, he can open the translation window 300 and key in a string in the input area 310 according to the pronunciation of the translation word, e.g. ‘fiziks’, and uses the cursor 301 to click the search element 320. In this case, the searching module 103 receives the string ‘fiziks’ as the search message, and uses this search message to find a matched translation word in the translation database 101.

Now suppose the translation database 101 does not have the translation word ‘fiziks’. The loading module 104 compares the search message ‘fiziks’ with all the similarity messages in the similar-sound database 102, and loads the word messages and weights according to the matched similarity messages. For example, suppose the similar-sound database 102 stores multiple word messages, e.g., ‘physics’, ‘physical’, and ‘physique’. Each of the word messages has the similarity message ‘fiziks’ and the corresponding weights ‘5’, ‘4’, and ‘3’, respectively. Since the search message ‘fiziks’ and the similarity message ‘fiziks’ match, the loading module 104 loads the word messages ‘physics’, ‘physical’ and ‘physique’, and the corresponding weights ‘5’, ‘4’, and ‘3’.

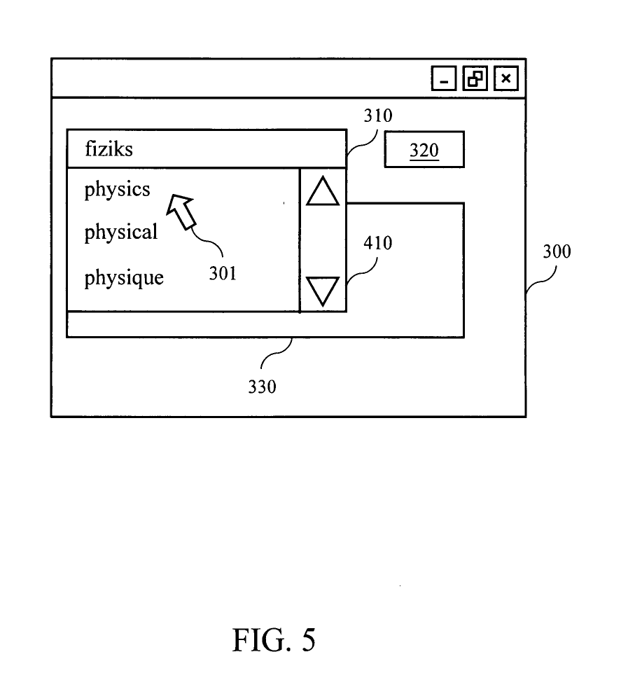

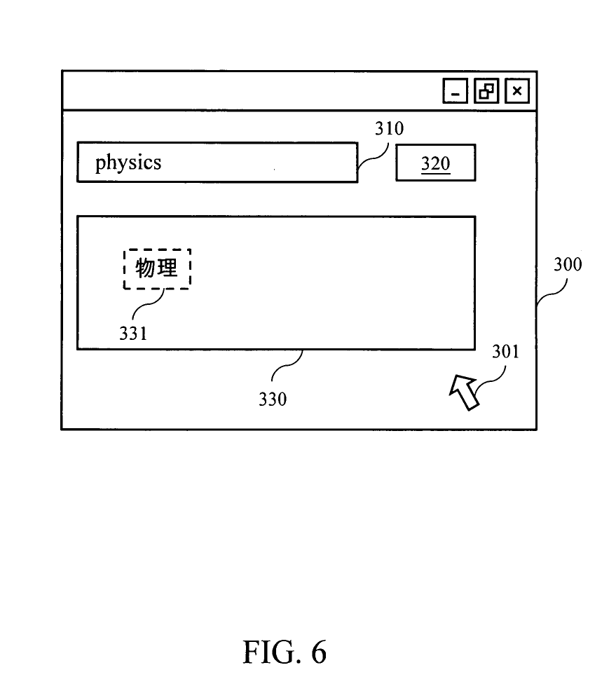

Afterwards, the correcting module 105 lists the loaded word messages (e.g., ‘physics’, ‘physical’, and ‘physique’) in the pull-down menu 410 according to the weights loaded by the loading module 104. In this case, as shown in FIG. 5, the user can use the cursor 301 to select one of the word messages in the pull-down menu 410, e.g., ‘physics’. Afterwards, the correcting module 105 uses the user selected word message ‘physics’ as the search message. The search message is used to find a matched translation word ‘physics’ in the translation database 101. Suppose the translation database 101 stores the translation word ‘physics’ with the word explanation ‘physics (in Chinese)’. Then after the correcting module 105 finds the matched translation word ‘physics’, the word explanation 331 thereof is displayed in the display area 330 of the translation window 300, as shown in FIG. 6.

It should be noted that when the user selects one of the loaded word messages, the correcting module 105 can increase the weight of the corresponding word message and updates it to the similar-sound database 102. Suppose the user selects the word message ‘physics’. Its weight is ‘5’. After the increment, a new weight (e.g., ‘6’) is obtained and updated to the similar-sound database 102.

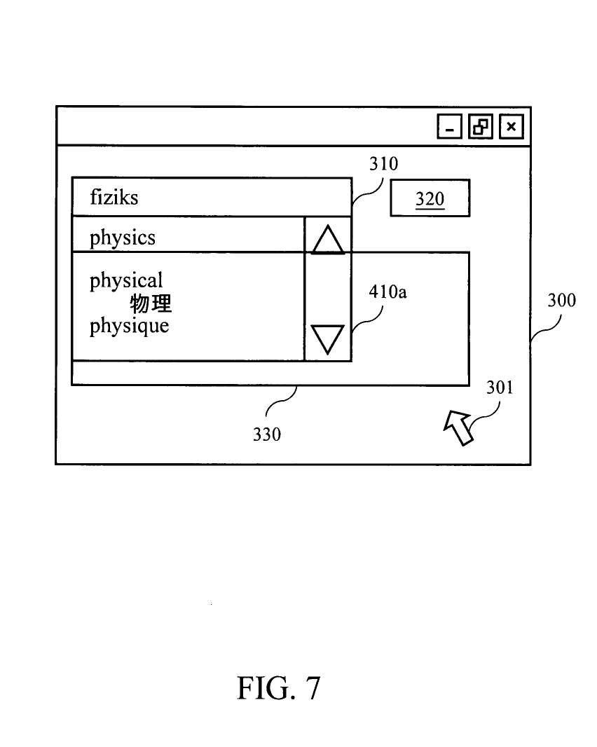

Finally, please refer to FIG. 7, which shows that the pull-down menu is adjusted to be half-transparent according to the invention. As mentioned before, the pull-down menu 410 can be adjusted as half-transparent by pressing a functional key or clicking with the cursor 301. In practice, the user can press a key (e.g., ‘F1’) on a physical keyboard in the pull-down menu or clicks the frame of the pull-down menu 410 with the cursor 301. The pull-down menu 410 is then adjusted to become a half-transparent pull-down menu 410a, as shown in FIG. 7. As a result, the half-transparent pull-down menu 410a does not cover the display area 330 and the display contents therein (e.g., ‘physics’).

In summary, the invention differs from the prior art in that the invention uses the search message to search for a matched translation word. When a matched translation word does not exist, the search message is compared with all the similar messages to find a matched word message. The word message is then used as the search message to find a matched translation word again. Through the above-mentioned techniques, the invention improves the convenience in searching for translation words.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An input correction system for translation searches, comprising:
a translation database having a plurality of translation words, each of which contains a word explanation;
a similar-sound database having a plurality of word messages and the corresponding similarity messages and weights;
a searching module for receiving a search message and finding a matched translation word in the translation database according to the search message;
a loading module for, when a matched translation word exists, loading the translation word to display the word explanation thereof and, when no matched translation word exists, comparing the search message with all the similarity messages and loading the word message and weights corresponding to matched similarity messages; and
a correcting module for displaying the loaded word message according to the weights thereof and, after one of the loaded word message is selected, using the selected word message as the search message to find a matched translation word in the translation database and display the word explanation of the matched translation word.

2. The input correction system for translation searches of claim 1, wherein the similarity messages is a string composed of the spelling letters of the word messages.

3. The input correction system for translation searches of claim 1, wherein the correcting module lists the loaded word messages in a pull-down menu in ascending or descending order of the weights.

4. The input correction system for translation searches of claim 3, wherein the pull-down menu is adjusted to be half-transparent by pressing a functional key or clicking with the cursor.

5. The input correction system for translation searches of claim 1, wherein after one of the word messages is selected, the correcting module further increases the weight of the selected word message and updates the weight to the similar-sound database.

6. An input correcting method for translation searches, comprising the steps of:
providing a translation database having a plurality of translation words, each of which contains a word explanation;
providing a similar-sound database having a plurality of word messages and the corresponding similarity messages and weights;
receiving a search message and finding a matched translation word in the translation database according to the search message;
when a matched translation word exists, loading the translation word to display the word explanation thereof and, when no matched translation word exists, comparing the search message with all the similarity messages and loading the word message and weights corresponding to matched similarity messages; and
displaying the loaded word message according to the weights thereof and, after one of the loaded word message is selected, using the selected word message as the search message to find a matched translation word in the translation database and display the word explanation of the matched translation word.

7. The input correction method for translation searches of claim 6, wherein the similarity messages is a string composed of the spelling letters of the word messages.

8. The input correction method for translation searches of claim 6 further comprising the step of listing the loaded word messages in a pull-down menu in ascending or descending order of the weights.

9. The input correction method for translation searches of claim 8, wherein the pull-down menu is adjusted to be half-transparent by pressing a functional key or clicking with the cursor.

10. The input correction method for translation searches of claim 6 further comprising the step of increasing the weight of the selected word message and updates the weight to the similar-sound database after one of the word messages is selected.
